(19) United States
(12) Patent Application Publication
(10) Pub. No.: US 2023/0255407 A1
(43) Pub. Date: Aug. 17, 2023

(54) SOLID LIQUID SEPARATOR

(71) Applicant: Starbucks Corporation, Seattle, WA (US)

(72) Inventors: Nathan C. Oren, Edgewood, WA (US); Joseph E. Gormley, Mercer Island, WA (US)

(21) Appl. No.: 17/813,881

(22) Filed: Jul. 20, 2022

Related U.S. Application Data
(60) Provisional application No. 63/268,037, filed on Feb. 15, 2022.

(51) Int. Cl. A47J 43/046; A47J 43/07

(52) U.S. Cl. CPC A47J 43/046; A47J 43/0716

(57) ABSTRACT

An apparatus for preparing foam can include a container comprising an open end and a closed end. The container can define an interior configured to contain the foam therein. The container can include a spout extending from the container. The spout can be configured to dispense the foam. The spout can include a plurality of slots positioned through a surface of the spout.

### CROSS-REFERENCE TO RELATED APPLICATION(S)

This application claims the benefit of U.S. Provisional Application No. 63/268,037, filed Feb. 15, 2022, which is hereby incorporated by reference in its entirety.

### FIELD

The present disclosure relates to systems and methods for dispensing a foam or blended media, such as, systems and methods for dispensing foam from a container or pitcher and separating the solids and liquids while dispensing the foam.

### BACKGROUND

Certain beverages are prepared with foams or blended media, which can be made with dairy or non-dairy are expanded with air. Certain beverages are prepared with cold foams that need to be frequently dispensed. In some examples, the foams can be made with milk or other liquids. The foam or blended media can be used to finish or top a beverage. Adding a foam or blended media can provide a flavor, texture, or visual interest that enhances the beverage. The foam or blended media can be customized by adding flavors and powders to change the color, taste or texture.

However, the typical process of foaming or blending/aerating dairy or non-diary can be time consuming and complex. The typical process can include mixing liquid dairy or non-dairy base with sweetener, flavor, syrups, or powders. The typical process can also include blending or aerating in an apparatus, such as a blender, or by hand. There can be a variety of foams and blended media, which require different amounts or speed of blending. Blending or aerating can leave various amounts of unblended liquid base, resulting in a mix of blended and unblended liquid. Pouring the foam or blended media can result in the unblended liquid to be poured into the beverage, which can be undesirable.

### SUMMARY

The systems, methods and devices of this disclosure each have several innovative aspects, no single one of which is solely responsible for the desirable attributes disclosed herein.

In certain embodiments, an apparatus for preparing foam can comprise a container comprising an open end and a closed end, the container defining an interior configured to contain the foam therein and a spout extending from the container, the spout configured to dispense the foam. The spout can comprise a plurality of slots positioned through a surface of the spout.

The apparatus for preparing foam can further include one or more of the following features. the blending mechanism can include one or more blades. The blending mechanism can include a whisk. The spout can open and close an opening through a side wall of the container. The spout can include a flat top surface and the plurality of slots are positioned through the flat top surface of the spout. The spout can include side walls, each of the side walls extending above the flat top surface. The spout can include a cylindrical tube. The plurality of slots can be positioned through a bottom surface of the cylindrical tube. The spout can extend near the closed end of the container. The apparatus can further include a catch basin positioned beneath the plurality of slots. The spout can include a protrusion of a lip of the open end of the container. The protrusion can include a top surface and a bottom surface, wherein the plurality of slots are positioned through the top surface of the protrusion. The spout can further include a return channel in fluid communication with the bottom surface of the protrusion and the interior of the container. The protrusion can extend to a distal end of the spout.

Certain embodiments of the present disclosure can include an apparatus for preparing foam that includes a container comprising an open end and a closed end, the container defining an interior configured to contain the foam therein and a spout extending from the open end of the container, wherein the spout comprises one or more side channels.

The apparatus for preparing foam can further include one or more of the following features. The spout can include a protrusion extending from a lip of the open end of the container. The protrusion can extend to a point at a distal end of the spout. The spout can further include a return channel in fluid communication with the one or more side channels and the interior of the container. The one or more side channels can include two side channels positioned on opposing lateral sides of a bottom surface of the spout, the spout further comprises a convex portion positioned between the two side channels.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A illustrates an embodiment of a solid liquid separator system.

FIG. 1B illustrates another embodiment of a solid liquid separator system.

FIG. 1C illustrates a cross sectional view of the spout of the solid liquid separator system of FIG. 1B.

FIG. 2A illustrates another embodiment of a solid liquid separator system.

FIG. 2B illustrates a close up view and bottom view of the solid liquid separator system of FIG. 2A.

FIG. 3A illustrates another embodiment of a solid liquid separator system.

FIG. 3B illustrates a close up view of another embodiment of a solid liquid separator system of FIG. 3A.

FIG. 3C illustrates a cross sectional view of the spout of the solid liquid separator system of FIG. 3B.

FIG. 3D illustrates another cross-sectional view of the spout of the solid liquid separator of FIG. 3B.

FIG. 3E illustrates an alternative embodiment of a close up, side view of the solid liquid separator system.

FIG. 3F illustrates an alternative embodiment of a close up, side view of the solid liquid separator system.

FIG. 3G illustrates a cross-sectional view of the spout of the solid liquid separator system of FIG. 3F.

### DETAILED DESCRIPTION

Various extraction systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein. For example, many of the embodiments are described in the context of preparing foam from liquid bases at room temperature or at temperatures colder than room temperature. However, certain features and aspects of the disclosure may also have utility in producing foams at temperatures above room temperature or from liquid bases at above room temperature.

Many of the embodiments described herein involve foaming liquid, such as milk or a non-dairy liquid. For instance, in some embodiments, the liquid to be foamed may be referred to herein as the “liquid base” or may be a dairy or non-dairy liquid, such as milk, cream, almond milk, soy milk, oat milk, coconut milk, cashew milk, other alternative milks, other plant-based liquids, coffee, tea, or hemp extract. In some examples, the liquid base can be a premanufactured mixture or a production of fresh ingredients. The liquid base can be modified using food grade modifiers including and not limited to gums, emulsifiers and thickeners. The composition of the liquid base may be fine-tuned with the modifiers to provide the desired texture and taste of the foam. The foam may also include syrup, powder, sweetener, flavor, or other inclusions.

For example, many of the embodiments are described in the context of creating and dispensing a foam from a container at room temperature or at temperatures colder than room temperature, which may be considered cold foams. However, certain features and aspects of the disclosure may also have utility in creating and dispensing foam at temperatures above room temperature or from liquid bases at above room temperature.

To produce edible cold foams safe for human consumption, the foam should be produced under sanitary conditions and need to be maintained at safe temperatures to prevent the growth of pathogens and prevent spoilage. The term “cold foam” as used herein is applied broadly to refer to foams prepared with the use of base or liquid base not exceeding 100° F. For instance, in certain configurations described herein, the liquid base may be maintained between 0° F. and 100° F. In certain embodiments, the temperature of the liquid base may be maintained between 30° F. and 50° F. and in certain embodiments between 30° F. and 40° F. and in certain embodiments between 60° F. and 70° F. In certain embodiments, the cold foam produced may have a temperature not exceeding 45° F. Certain aspects of the embodiments disclosed below are particularly advantageous to dispensing “cold foams” and are often described in the context of dispensing a cold foam. However, it should be appreciated, that certain aspects and features of the embodiments disclosed herein are not limited to embodiments that dispense cold foams but also can find utility in producing hot or warm foams such as, but not limited to, cold foams that are blended with warm or hot foams.

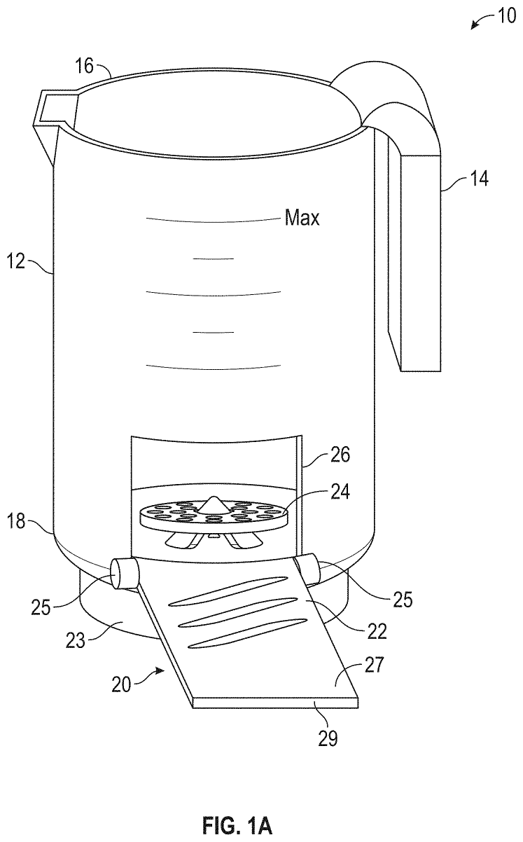

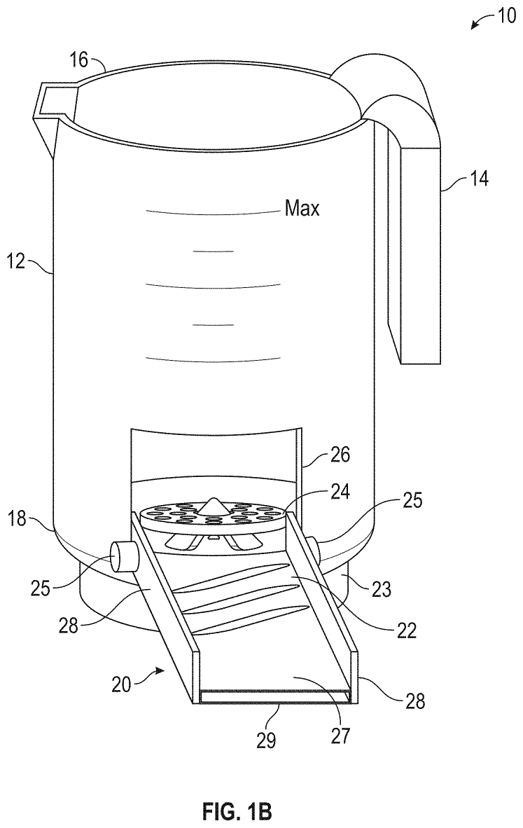

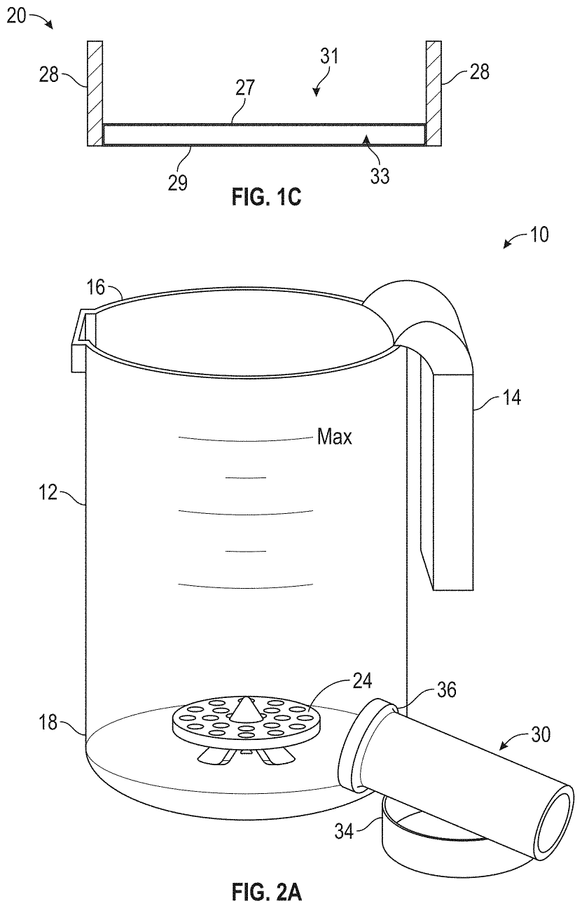

FIG. 1A illustrates an embodiment of a solid liquid separator system or apparatus 10. The system 10 can include a container or pitcher 12 with a first end or portion 16 and a second end or portion 18. The first end or portion 16 can be at a top of the apparatus and can be open. The second end or portion 18 can be at a bottom of the apparatus and can be closed. The system 10 can also include a blending mechanism 24, such as one or more blades or whisks, which can be actuated (e.g., rotated) to blend or aerate the ingredients (such as liquid base) within the container 12. The blending mechanism 24 can be located near the closed, bottom portion 18 of the container 12. The system 10 can also include a handle 14, which can be gripped by a user to maneuver the system 10. The handle 14 can extend near the open, top portion 16 of the container 12.

The system 10 can further include a spout or channel 20. The spout 20 can extend from a bottom portion of the container or pitcher 12. One end of the spout 20 can extend through the side wall of the container or pitcher 12. The channel 20 can be in fluid communication with the interior of the container or pitcher 12. The spout 20 can funnel the contents of the container 12. FIG. 1A illustrates a spout or channel 20 without side walls. As shown in FIGS. 1B and 1C, the spout 20 can include side walls 28 that extend on either side of the spout 20 to maintain the contents within the spout 20. The spout 20 can include a top surface 27 and an opposing bottom surface 29. The top surface 27 can be flat or concave to retain the contents of the container 12 on the top surface 27 of the spout 20. The spout 20 can have a rectangular section taken transverse to a length of the tube 20, such as shown in FIG. 1A. In other examples, the spout 20 can have a rounded or cylindrical outer surface. In other embodiments, the spout 20 can have other shapes cross sections, such as circular, oval, elliptical, triangular, or square. The top surface 27 can include a plurality of openings or slots 22. The plurality of openings or slots 22 can be angled or diagonal relative to the longitudinal axis of the spout 20. In other examples, the plurality of openings or slots 22 can be substantially parallel to or substantially perpendicular to the longitudinal axis of the spout 20. In some examples, the plurality of openings or slots 22 can extend along a portion of the top surface 27. In certain embodiments, the slots can have a width of from 0.5 mm to 4 mm and/or in certain embodiments a depth of from 0.5 mm to 4 mm. In other examples, the plurality of openings or slots 22 can extend along the entire length of the top surface 27. The spout 20 can have a flat top surface 27 and a flat bottom surface 29. The spout 20 can further include two sides or side walls extending between the flat top surface 27 and the flat bottom surface 29. The plurality of openings or slots 22 can be positioned through a top surface 27 of the spout 20. In some examples, as shown in FIGS. 1B and 1C, the spout 20 can include side walls or sides 28 that extend above the top surface 27 of the spout 20. This can advantageously retain the contents flowing along the top surface 27 of the spout 20 and prevent content from spilling over the sides of the spout 20.

In some configurations, the system 10 can include an opening or window 26 which extends through a wall or side of the container 12. The system 10 can further optionally include a gate or rotational mechanism 25 that can close or seal the opening 26. This can prevent the contents of the container 12 from escaping through the opening 26, thus keeping the contents within the container 12 when desired, such as when ingredients are being added to the container 12 or during blending of the ingredients. The gate or rotational mechanism 25 can open the opening 26 to dispense the contents of the container 12 out from the opening 26 and through the spout 20. For example, the gate or rotational mechanism 25 can lower and raise the spout 20. The spout 20 can act as a door that opens and closes the opening 26. In the closed position, the top surface 27 and/or the bottom surface 29 can act as a side wall of the container 12 to seal the opening 26 of the container 12. In the open position, the spout 20 can extend and protrude from the side of the container 12. In certain embodiments, the spout can form an angle with the side of the container between 30 to 85 degrees. In some examples, the spout 20 can be positioned substantially transverse from the side wall of the container 12. In other examples, the spout 20 can be positioned angled at an obtuse angle from the side wall of the container 12. In this manner, the spout 20 can extend near a closed end 18 of the container 12. The spout 20 can be positioned such that the opening 26 is open and contents from the interior of the container 12 can flow from the interior of the container 12 and onto the top surface 27 of the spout 20 The spout 20 including the side walls 28 that extend above the top surface 27 of the spout can also open and close the opening 26 of the container 12. The side walls 28 can be positioned within the interior of the container 12 when the spout 20 is in the closed position.

The pitcher 12 can receive one or more ingredients, such as a liquid base and a syrup. The blending mechanism 24 can be actuated, such as by rotating the blending mechanism 24, to blend ingredients placed in the container 12. In some examples, the blending mechanism 24 can be actuated by a motor 23. The actuation of the blending mechanism 24 positioned in the one or more ingredients can blend the ingredients and expand the ingredients with air to create foam or mixed media. After blending, the contents of the container 12 can include a mixture of blended liquid base (foam or mixed media) and unblended liquid base. The contents of the container 12 can further include modifiers, such as syrup, powder, sweetener, flavor, or other inclusions, which can be mixed in to the blended or unblended liquid base. When the opening 26 is open, the contents within the container 12 can flow from the interior of the container 12, through the opening 26, and dispensed out through the spout 20 along the top surface 27 of the spout. The flow from the interior of the container 12, through the opening, from a first end of the spout 20 and out from a second end of the spout 20 along the top surface of the spout 27 can be considered the flow or dispensing path. The flow through the dispensing path can dispense contents of the container 12 into a beverage. As the contents flow through the spout 20, the unblended liquid base, which is heavier and denser, will move towards the bottom of the flowing contents and towards the top surface 27 of the spout 20, due to gravity. When near the top surface 27 of the spout 20, the unblended liquid base can pass through or drain through the slots 22, thus exiting the dispensing path and not reach the beverage. The unblended liquid base can exit the dispensing path along the top surface 27 of the spout 20 and then flow between the top surface 27 and the bottom surface 29 of the spout 20. The blended foam or mixed media, which is lighter and less dense, can continue to flow through the dispensing path, from the interior of the container 12, along the length of the top surface 27 of the spout 20, and out from the end of spout 20, such as into a beverage.

As shown in FIG. 1C, the spout 20 has an opening defined between the top surface 27 and the bottom surface 29 to allow for drainage of the unblended liquid base. In some examples, the bottom surface 29 can at least be positioned under the slots 22 of the top surface 27. In this manner, contents from the interior of the container, including foam, can travel along a path 31 along the top surface 27 and between the two side walls 28, while unblended liquid can be separated from the contents due to gravity and run through the slots 22 into a second path 33, between the top surface 27 and the bottom surface 29. The bottom surface 29 can act as a catch basin or drain that can be positioned beneath the slots 22 of the spout 20. The catch basin or drain can catch any of the contents that pass through the slots 22 of the spout 20, such as the unblended liquid base.

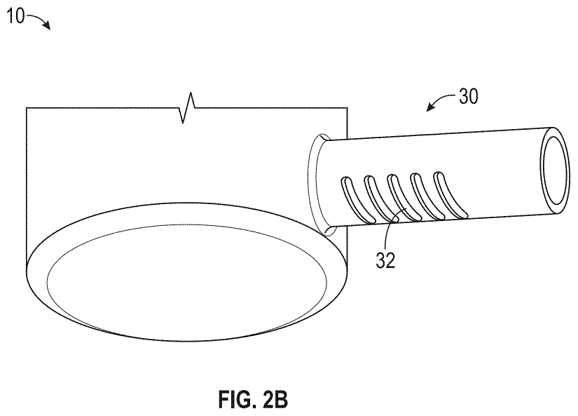

As shown in FIGS. 2A and 2B, the system 10 can include a spout 30 in the form of a cylindrical tube. The spout 30 can extend from a bottom portion 18 of the container or pitcher 12. One end of the spout 30 can extend through the side wall of the container or pitcher 12. The spout 30 can function similarly to the spout 20 to separate and drain the unblended liquid base from the blended foam or mixed media. The spout 30 can be in fluid communication with the interior of the container or pitcher 12. The spout 30 can funnel the contents of the container 12. As shown in FIG. 2B, the spout 30 can include a plurality of openings or slots 32. In some examples, the plurality of openings or slots 32 can extend along a portion of the spout 30. In certain embodiments, the slots can have a width of from 0.5 mm to 4 mm and/or in certain embodiments a depth of from 0.5 mm to 4 mm. In other examples, the plurality of openings or slots 32 can extend along the entire length of the spout 30. The spout 30 can have a circular or oval cross section taken transverse to a length of the tube 30. The spout 30 can have a rounded or cylindrical outer surface. In other embodiments, the spout 30 can have other shapes cross sections, such as such as oval, elliptical, triangular, square, or rectangular. As shown in FIG. 2B, the plurality of openings or slots 32 can be positioned on a bottom portion or surface of the tube 30. The plurality of openings or slots 32 can be angled or diagonal relative to the longitudinal axis of the spout 30. In other examples, the plurality of openings or slots 32 can be substantially parallel to or substantially perpendicular to the longitudinal axis of the spout 30. In some examples, the plurality of openings or slots 32 can extend along a portion of the bottom surface of the spout 30. In other examples, the plurality of openings or slots 32 can extend along the entire length of the bottom surface of the spout 30. The spout 30 can include optionally include a cover or a valve 36, which will prevent contents of the container 12 from flowing through the spout 30 until the time of dispense. The cover can be removed or the valve can be opened when dispensing is desired. In some examples, the cover or valve can be positioned in various positions along the length of the spout 30, such as on a first end of the spout 30 as shown in FIG. 2A, a second end of the spout 30, or in between the first end and second end of the spout 30.

In some examples, the system 10 can further include a catch basin or drain that can be positioned beneath the slots 22, 32 of the spout 20, 30. The catch basin or drain can catch any of the contents that pass through the slots 22, 32 of the spout 20, 30 such as the unblended liquid base. In some examples, the catch basin or drain can be integral with the spout 20, such as the bottom surface 29 described above in FIGS. 1B-1C. In other examples, the catch basin or drain 34 can be a separate piece that is external to the spout 30, such as shown in FIG. 2A.

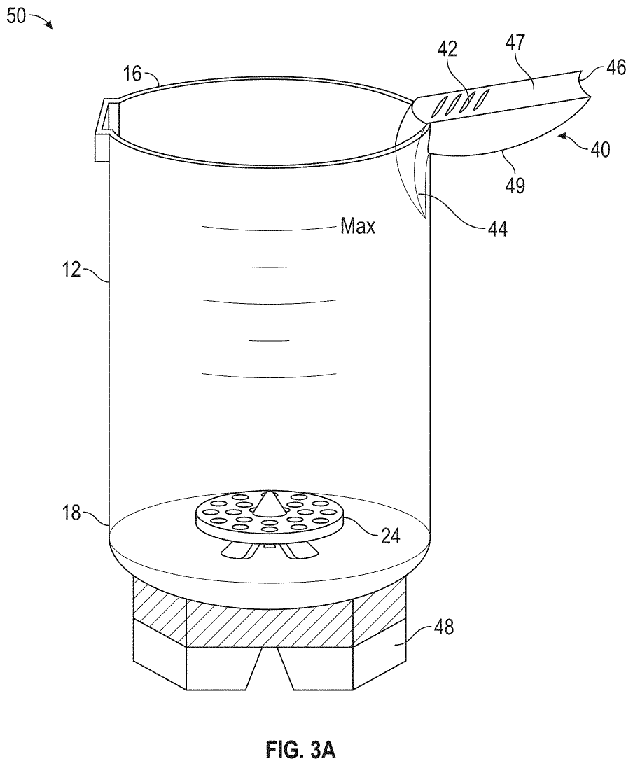

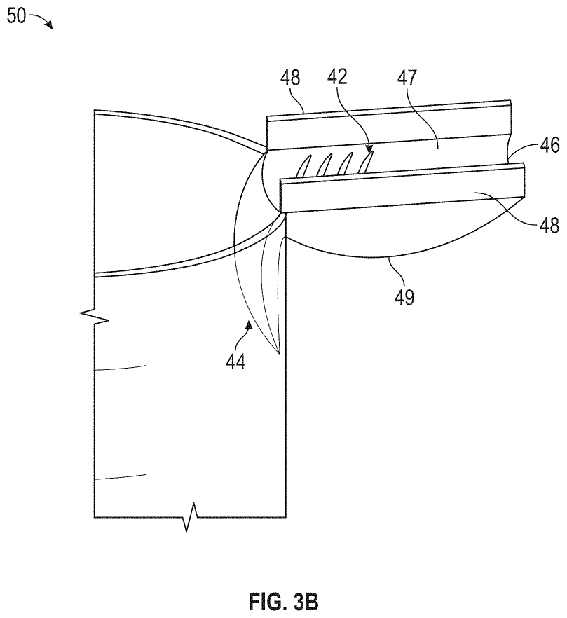

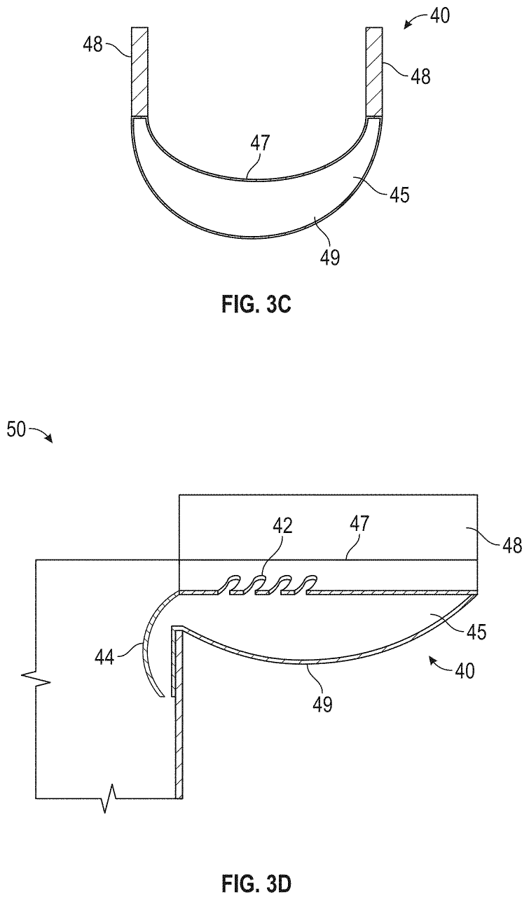

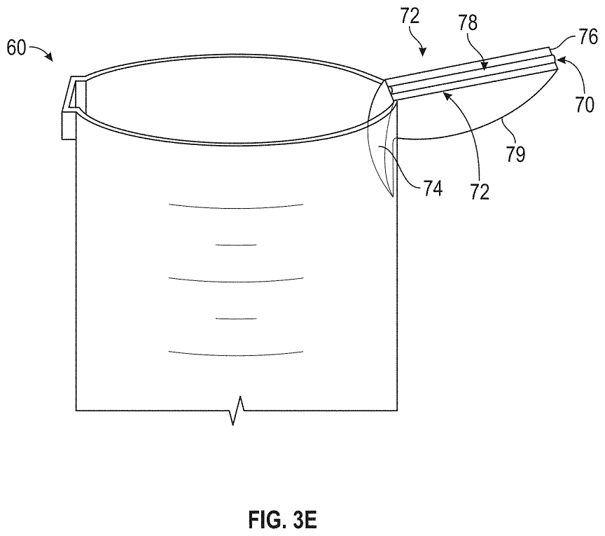

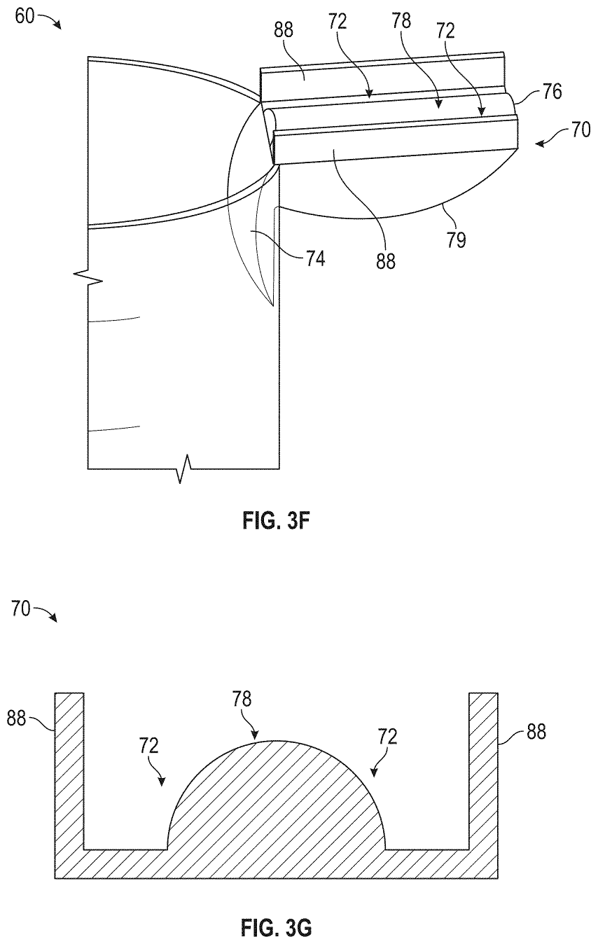

FIG. 3A illustrates another embodiment of a solid liquid separator system or apparatus 50. Similar to the systems 10 described above, the system 50 can include a container or pitcher 12 with a first end or portion 16 and a second end or portion 18. The first end or portion 16 can be at a top of the apparatus and can be open. The second end or portion 18 can be at a bottom of the apparatus and can be closed. The system 50 can also include a blending mechanism 24, such as a blade or a whisk, which can be actuated (e.g., rotated) to blend or aerate ingredients (such as liquid base) within the container 12. The blending mechanism 24 can be located near the closed portion 18 of the container 12. The system 50 can also include a base 48 extending from the bottom portion 18 of the container 12. The base 48 can be configured to engage with a motor which can actuate the blending mechanism 24. The base 48 can also lock the container 12 to another component, such as a blending motor base.

The system 50 can further include a spout 40. The spout 40 can extend from a top, open end 16 of the container 12. The spout 40 can include an extension or protrusion of the lip of the open end 16 of the container 12. The extension or protrusion can extend to a point at a terminal or distal end 46 which will funnel or direct the contents of the container 12 out from the spout 40. The spout 40 can include a top surface 47. The top surface 47 can include a plurality of openings or slots 42. The spout 40 can also include a bottom surface 49 that is positioned below the top surface 47. The spout 40 can define a cavity 45 between the top surface 47 and the bottom surface 49. The spout 40 can include sides extending between the top surface 47 and the bottom surface 49. FIG. 3A illustrates a spout 40 without side walls. As shown in FIG. 3B, the spout 40 can also include side walls 48 on opposing lateral sides of the spout 40 that extend above the top surface 47 of the spout 40. The side walls 48 can extend on either side of the spout 40 to maintain the contents on the top surface 47 of the spout 40. As shown in FIG. 3C, the top surface 47 can be concave. Similarly, the bottom surface 49 can also be concave and can be positioned below the top surface 47.

The spout 40 can function similarly to the spouts 20, 30 as described herein, to separate and drain the unblended liquid base from the blended foam or mixed media, as the contents of the container 12 are being dispensed. In the system 50, once the ingredients (such as liquid base and a modifier) have been blended, the contents of the container 12 can be dispensed by tilting or rotating the container 12 to pour out the contents of the interior 12. When the container 12 is tilted, the contents of the container 12 can be poured out the open, top portion 16 to flow towards and out of the spout 40. The spout 40 can define a flow path from one end of the spout 40 connected to the open end 16 of the container 12 towards the opposing end of the spout 40, which can be the distal end 46 of the spout 40 along the top surface 47 of the spout 40. The spout 40 can be in fluid communication with the interior of the container 12. The spout 40 can funnel the contents of the container 12. When the container 12 is tilted, the contents within the interior of the container 12 can flow along the flow path of the spout 40 and out of the system, such as into a beverage. As the mixture of the blended foam and the unblended liquid base flows in the flow path of the top surface 47 of the spout 40, the unblended liquid base, which is heavier and denser than the blended foam, will move towards the top surface 47 of the spout 40 due to gravity. The unblended liquid base can then pass through or drain through the slots 42 positioned through the top surface 47, thus exiting the flow path and not reach the beverage. The blended foam or mixed media, which is lighter and less dense, can flow through the flow path, from the interior of the container 12, along the flow path of the top surface 47 of the spout 40, and out from the end 46 of the spout 40, such as into a beverage. The unblended liquid base can then pass through the slots 42 of the top surface 47 out of the flow path, into the cavity 45 between the top surface 47 and the bottom surface 49.

As shown in FIGS. 3A-3B and FIG. 3D, the spout 40 can further include a channel 44, which can be a return channel, in fluid communication with or extending between the plurality of slots 42, the cavity 45 positioned between the top surface 47 and the bottom surface 49, and the interior of the container 12. The unblended liquid base can pass through or drain through the plurality of slots 42 and into the cavity 45. The unblended liquid base can travel through the cavity 45 defined between the top surface 47 and the bottom surface 49 of the spout. The container 12 can then be positioned upright, such that it is no longer tilting, and the unblended liquid base from the cavity 45 above the bottom surface 49 of the spout 40 can then flow into the channel 44 and return to the interior of the container 12. This advantageously allows the unblended liquid base to not only be captured and collected, but can also be reused to prepare further foams or mixed media as it is returned to the interior of the container 12.

FIG. 3E illustrates an embodiment of a solid liquid separator system or apparatus 60. The system 60 can include a container or pitcher 12 and a spout 70. The spout 70 can include an extension or protrusion of the lip of the open end 16 of the container 12. The extension or protrusion of the spout 70 can extend to an end 76 to aid in funneling or directing the contents of the container 12 out from the spout 70. The end 76 can be at a point at a terminal or distal end of the spout 70. As shown in FIG. 3F, the spout 70 can include side walls 88 that extend on either side of the spout 70 to maintain the contents within the spout 70.

The spout 70 can include one or more side channels 72 to allow for drainage. In some examples, the one or more side channels 72 can include channels positioned on each of two sides of the spout 70. In some examples, the one or more side channels 72 can at least be positioned on two opposing lateral sides on a bottom surface of the spout 70, such as shown in FIGS. 3E-3G. In some examples, the spout 70 can further include a convex region 78 positioned between the two side channels 72 of the spout 70. The convex region 78 can extend above the top surface of the spout 70. In this manner, foam can travel along the convex area or portion 78 between the two side channels 72 and/or between the two side walls 88, while liquid base can run off the convex area 78 and into the one or more side channels 72. As shown in the example of FIG. 3E, foam can travel along the convex area 78 while liquid base can run off the convex area 78 and into the one or more side channels 72. The one or more side channels 72 can be positioned on opposing lateral sides of the convex area 78. As shown in the example of FIGS. 3F-3G, foam can travel along the convex area 78 while liquid base can flow through the side channels 72 positioned between the convex area 78 and each of the side walls 88. In some examples, the one or more side channels 72 can have a cross-sectional diameter or width of at least 5 mm, and in some embodiments at least 3 mm.

The spout 70 can function similarly to the spouts 20, 30, 40 of other embodiments described herein, to separate and drain the unblended liquid base from the blended foam or mixed media, as the contents of the container 12 are being dispensed through the spout 70. In the system 60, once the ingredients (such as liquid base and a modifier) have been blended, the contents of the container 12 can be dispensed by tilting or rotating the container 12. When the container 12 is tilted, the contents of the container 12 can be funneled towards the spout 70 and flow out of the spout 70. The spout 70 can define a flow or dispensing path from one end of the spout 70 connected to the open end of the container 12 towards the opposing end of the spout 70, which can be the distal end 76 of the spout 70. The spout 70 can be in fluid communication with the interior of the container 12. The spout 70 can funnel the contents of the container 12. When the container 12 is tilted, the contents within the interior of the container 12 can flow towards the flow path of the spout 70 and out of the system 60, such as into a beverage. As the mixture of the blended foam and the unblended liquid base flows in the flow path of the spout 70, the unblended liquid base, which is heavier and denser than the blended foam, will move towards a bottom surface of the spout 70 due to gravity. As previously described, the blended foam can travel along the flow path along the convex area 78 from one end of the spout 70 to the distal end 76 of the spout 70. The unblended liquid base can separate from the blended foam such that the unblended liquid base can run off the sides of the convex area 78 and into the side channels 72 on opposing lateral sides of the convex area 78. The unblended liquid base can then move into and through the one or more side channels 72 and thus exiting the flow path and not reach the beverage. The blended foam or mixed media, which is lighter and less dense, can flow through the flow path, from the interior of the container 12, along the flow path of the spout 70 on the convex area 78, and out through the end 76 of the spout 70, such as into a beverage.

As shown in FIGS. 3E and 3F, the spout 70 can further include a return channel 74 in fluid communication with or extending between the one or more side channels 72 and the interior of the container 12. The unblended liquid base can pass through or drain through the one or more side channels 72. The container 12 can then be positioned upright, such that the container 12 is no longer tilted, and the unblended liquid base can then flow from the side channels 72 and into the return channel 74 and back into the interior of the container 12. This advantageously allows the unblended liquid base to not only be separated, captured and collected, but also reused to prepare further foams or mixed media.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. An apparatus for preparing foam, the apparatus comprising:
a container comprising an open end and a closed end, the container defining an interior configured to contain the foam therein; and
a spout extending from the container, the spout configured to dispense the foam,
wherein the spout comprises a plurality of slots positioned through a surface of the spout.

2. The apparatus of claim 1, further comprising a blending mechanism.

3. The apparatus of claim 2, wherein the blending mechanism comprises one or more blades.

4. The apparatus of claim 2, wherein the blending mechanism comprises a whisk.

5. The apparatus of claim 1, wherein the spout opens and closes an opening through a side wall of the container.

6. The apparatus of claim 5, wherein the spout comprises a flat top surface and the plurality of slots are positioned through the flat top surface of the spout.

7. The apparatus of claim 6, wherein the spout comprises side walls, each of the side walls extending above the flat top surface.

8. The apparatus of claim 1, wherein the spout comprises a cylindrical tube.

9. The apparatus of claim 8, wherein the plurality of slots are positioned through a bottom surface of the cylindrical tube.

10. The apparatus of claim 1, wherein the spout extends near the closed end of the container.

11. The apparatus of claim 1, further comprising a catch basin positioned beneath the plurality of slots.

12. The apparatus of claim 1, wherein the spout comprises a protrusion of a lip of the open end of the container.

13. The apparatus of claim 12, wherein the protrusion comprises a top surface and a bottom surface, wherein the plurality of slots are positioned through the top surface of the protrusion.

14. The apparatus of claim 13, wherein the spout further comprises a return channel in fluid communication with the bottom surface of the protrusion and the interior of the container.

15. The apparatus of claim 12, wherein the protrusion extends to a distal end of the spout.

16. An apparatus for preparing foam, the apparatus comprising:
a container comprising an open end and a closed end, the container defining an interior configured to contain the foam therein; and
a spout extending from the open end of the container,
wherein the spout comprises one or more side channels.

17. The apparatus of claim 16, wherein the spout comprises a protrusion extending from a lip of the open end of the container.

18. The apparatus of claim 17, wherein the protrusion extends to a point at a distal end of the spout.

19. The apparatus of claim 16, wherein the spout further comprises a return channel in fluid communication with the one or more side channels and the interior of the container.

20. The apparatus of claim 16, wherein the one or more side channels comprises two side channels positioned on opposing lateral sides of a bottom surface of the spout, the spout further comprises a convex portion positioned between the two side channels.
